(19) United States
(12) Patent Application Publication
(10) Pub. No.: US 2013/0079938 A1
(43) Pub. Date: Mar. 28, 2013

(54) CUSTOMER SEGMENTATION BASED ON SMART METER DATA

(71) Applicants: Simon Lee, Castro Valley, CA (US); Zhe Pu, San Francisco, CA (US); Gotthard Goetzinger, Eppelborn (DE); Christine Preisach, Sankt Leon-Rot (DE); Michael Haft, Zorneding (DE); Alan Southall, Walldorf (DE); Andreas Vogel, San Francisco, CA (US)

(72) Inventors: Simon Lee, Castro Valley, CA (US); Zhe Pu, San Francisco, CA (US); Gotthard Goetzinger, Eppelborn (DE); Christine Preisach, Sankt Leon-Rot (DE); Michael Haft, Zorneding (DE); Alan Southall, Walldorf (DE); Andreas Vogel, San Francisco, CA (US)

(73) Assignee: SAP AG, Walldorf (DE)

(21) Appl. No.: 13/239,922

(22) Filed: Sep. 22, 2011

(51) Int. Cl. G05B 15/02

(52) U.S. Cl. 700/291

(57) ABSTRACT

A method and system to determine customer segmentation based on energy consumption patterns is provided. An example system includes a communications module, a clustering module, and a matching module. The communications module obtains energy consumption data in the form of a plurality of value days. The clustering module groups the value days associated with a certain period of time into a set of clusters. The matching module identifies a customer profile as associated with a cluster from the set of clusters based on results of examining value days associated with the customer profile.

### TECHNICAL FIELD

This application relates to the technical fields of software and/or hardware technology and, in one example embodiment, to system and method to determine customer segmentation based on smart meter data.

### BACKGROUND

With the advent of Smart Grid technology and Advanced Metering Infrastructure (AMI) utility companies now have an opportunity to analyze the actual energy consumption patterns of their customers. AMI data may be collected by so-called smart meters. A smart meter is a device that can be installed at the customer's premises that collects, periodically, consumption of electric energy and automatically communicates this collected information to the utility company. A smart meter may be configured to collect energy consumption information in certain intervals, e.g., in intervals of an hour or less.

The analysis of consumption patterns based on actual AMI data represents a major technical challenge due to the sheer scale of the problem: millions of customers multiplied by energy consumption reading occurring as often as at fifteen minute intervals. As a result, marketing departments of utility companies have to rely on simple consumption measurements (such as, e.g., average monthly energy consumption by a customer) and master data attributes (such as, e.g., geographical location of a customer) in order to segment the customers and market energy products and services to them.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is an example user interface illustrating respective shapes of pattern profiles, in accordance with an example embodiment;

FIG. 2 is an example user interface illustrating a multi-dimensional chart, in accordance with an example embodiment;

FIG. 3 is an example user interface illustrating a histogram reflecting respective numbers of customers that consume energy within respective ranges, in accordance with an example embodiment;

FIG. 4 is an example user interface illustrating a histogram reflecting value scores assigned to different customers, in accordance with an example embodiment;

FIG. 5 is a diagrammatic representation of a network environment within which an example method and system to determine customer segmentation may be implemented;

FIG. 6 is a block diagram of a system to determine customer segmentation, in accordance with one example embodiment;

FIG. 7 is a flow chart of a method to determine customer segmentation, in accordance with an example embodiment;

FIG. 8 is a flow chart of a method to determine customer segmentation, in accordance with an example embodiment; and

FIG. 9 is a diagrammatic representation of a screen flow

FIG. 10 is a diagrammatic representation of an example machine in the form of a computer system within which a set of instructions, for causing the machine to perform any one or more of the methodologies discussed herein, may be executed.

### DETAILED DESCRIPTION

A method and system to determine customer segmentation based on smart meter data is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

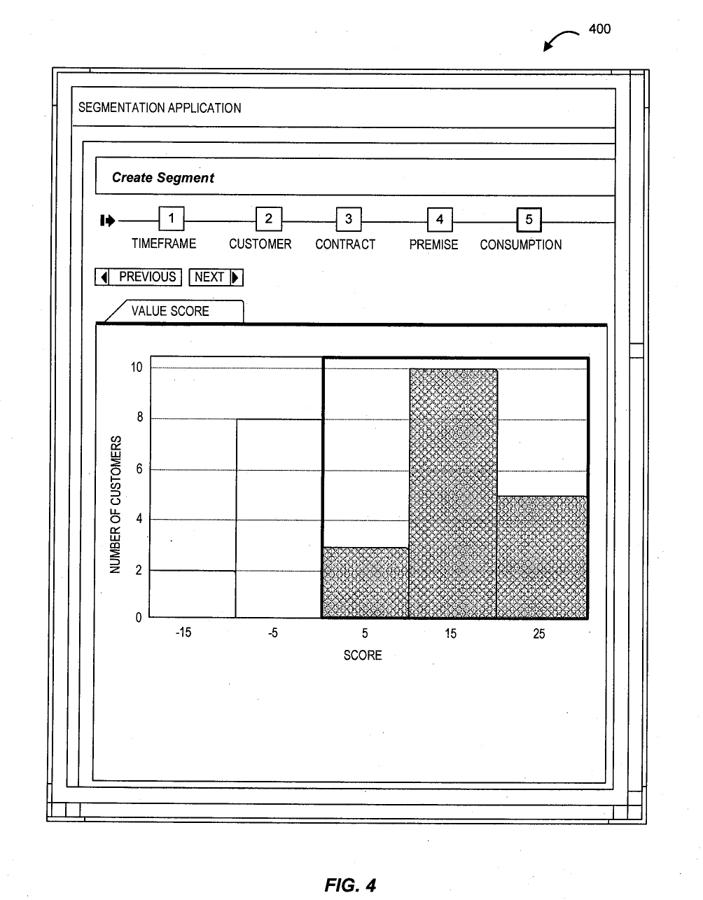

Method and system are provided for using smart meter data—energy consumption data collected periodically with high frequency—to segment energy customers (or electronic profiles of energy customers) into groups. Segmentation of customers may be achieved by using data reflecting distribution of energy usage among the customers. For example, a histogram may be used to segment customers based on their respective energy consumption during peak hours (e.g., between 8 AM and 6 PM). Another approach to segmentation may utilize revenue, cost, and profit data attributed to individual customers based on smart meter data. For example, a customer may be assigned a value score based on the energy cost attributed to the customer, and the customer profiles may be segmented based on the customer's respective value scores. Some examples of calculations involved in generating a value score for a customer are described further below, with reference to FIG. 4.

Another approach to segmentation includes utilizing consumption percentile filter parameters to select customers based on key consumption measures in terms of percentile. An example segmentation application may be configured to permit a user select customer profiles based on a certain percentile with respect to energy consumption. For example, a user may be permitted to select a certain top/bottom percent of customers characterized by high/low energy consumption measured in kWh. The percentile-based filtering may be used for a certain time period, e.g., during peak hours, during off-peak hours, etc. Furthermore a segmentation application may be configured to permit a user to toggle between daily average vs. monthly average vs. total with respect to consumption measures. The average energy consumption value may be calculated by averaging the energy consumption measurements collected during the specified days. For example, if the months of July and August are selected via the global date selector, only those days are used to calculate these average energy consumption measures or the total energy consumption measure.

Yet another approach to segmentation includes utilizing statistical analysis for pattern recognition that allows the utility companies to segment customers with a certain level of precision and provide insight into the energy usage patterns of individual customers. In one example embodiment, such method and system are implemented as a segmentation application that is configured to apply statistical clustering and pattern recognition techniques to the voluminous energy consumption data collected by smart meters and, based on the results of the processing, generate so-called pattern profiles (also termed clusters) that represent energy usage patterns in the course of a period of time (e.g., a 24 hour period, a day, a week, etc.). With the insight provided by these pattern profiles, the customers (or rather profiles or accounts representing respective energy customers) may be grouped based on their associated energy usage patterns.

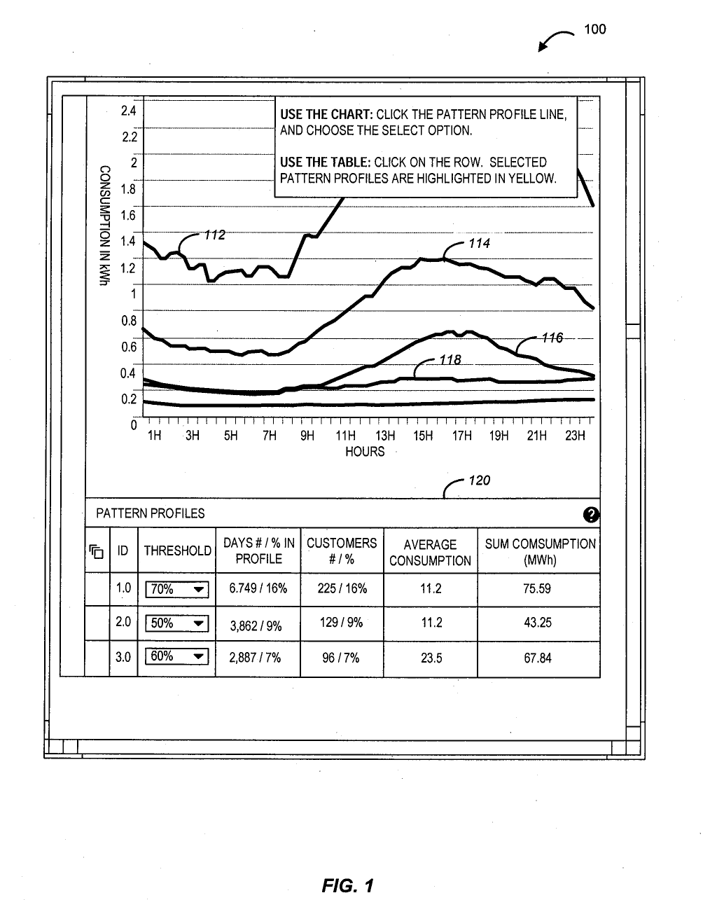

The smart meter data may be represented in the form of value-days, where a value-day comprises energy consumption measurements for a customer at different times during a 24-hour period. A value day may thus be viewed as represented by a curve having a shape determined by a plurality of time/energy consumption value pairs. Each value day is associated with a profile of a particular energy customer. Conversely, a customer profile may be associated with energy consumption data in the form of value days. A cluster of value days (also termed a pattern profile), created by applying one of a variety of statistical clustering algorithms (one example of which being the k-means algorithm) to a set of value days, contains those value days that have curves of similar shapes and thus represent a particular energy usage pattern. An example user interface 100 showing pattern profiles may be described with reference to FIG. 1. As shown in FIG. 1, area 110 displays four graphs representing four respective pattern profiles—reference numerals 112, 114, 116, and 118. The graphs 112, 114, 116, and 118 represent energy consumption measurements taken in the course of a 24-hour period. The graph 116, for example indicates greater increase of energy usage during the peak hours (e.g., during the hours of 7:00 and 19:00).

After the clusters have been determined, the segmentation application may examine customer profiles associated with a group of customers to determine, for a particular customer profile, which cluster most closely reflects the customer's energy usage pattern. The system may be configured to determine that a particular customer profile is to be associated with a particular cluster by determining whether a certain percentage of value days associated with the customer profile (and the time frame specified for the cluster) are from that particular cluster. A segmentation application may be configured to determine that two value days are similar enough to be in the same cluster based on absolute values of energy measurements. Alternatively, a segmentation application may be configured to determine that two value days are similar enough to be in the same cluster based on normalized values of energy measurements, such that the shapes of the curves associated with respective value days are being compared. In area 120, there provided controls for selecting a percentage threshold for a pattern profile in the column labeled “Threshold.” For example, as can be seen in area 120, those customer profiles, for which 70% of the value days collected for a specified period are associated with the pattern profile with the ID “1.0” (that corresponds to the curve identified by reference numeral 112), are also identified with that pattern profile.

In one example embodiment, a user interface illustrating a graph associated with a particular pattern profile may also include a graphical representation, termed a multi-dimensional chart (MDC chart), of statistics associated with energy customers' profiles that have been identified as associated with that pattern profile. An MDC chart is a stacked bar chart with each bar representing a dimension in a customer profile (e.g., business partner type, product category, etc.). Each stack is a dimension value (e.g., residential customer or product XYZ) and the size of each stack represents the % of its contribution, where the entire bar adds up to 100%.

In one embodiment, a segmentation application supports the following three example use cases of MDC charts. First, the composition of the current filter selection may be characterized by displaying the percentage/count of different values in a dimension. For example, 80% or 1948 customers are on Tariff X in the current selection. Second, an additional filter criterion may be selected by clicking on a stack to apply the selected stacks as additional filter criteria. For example, a user may drag-select Tiered rate X and Tiered Rate Y and use these as additional filter selection criteria (in addition to whatever has already been applied). Third, an MDC chart data generated for one segment may be compared with MDC data generated for a different segment. For example, 80% or 1948 customers are on Tariff X in the current selection may be compared to 60% or 20,000 customers on Tariff X in segment XYZ (a segment that the user selects as the basis of comparison). Some of the dimensions that may be supported by a segmentation application are shown in Table 1 below.

TABLE 1

Business
Partner Type
Industry code
Account Class
Installation
Type
Device
Category
Meter Type
Division
Credit Rating
Payment
Method
Contract Start
Date
Contract End
Date
Product
Category
Product ID
Tariff Category
Tariff ID

In some embodiments, smart meter data may also be used to generate histograms. A histogram chart is a technique to show the underlying composition of the customer selection based on a sorted measure or a value score. A histogram chart may be used for data visualization and interaction as an available choice across all filters. In some embodiments, a segmentation application may be configured to permit a user to select any measure to be graphed on the X axis, where the number of customers is displayed as the Y axis for the bins/bars. A segmentation application may automatically scale the chart to show the histogram with the right number of bins (i.e., the bars in the chart). For example, the user selects monthly consumption as the measure and the underlying data has a range between 500 to 3000 kWh. The segmentation application, based on this data and the screen resolution, determines that 25 bars or bins, each covering a range of 100 kWh, should be graphed on the chart. A segmentation application may be configured to permit a user to select a specific range of values and view a preview of the number of customers. For example, a user may select a range of 1000 to 1500 kWh from the previous example using this chart, and this particular selection is added to the overall filters.

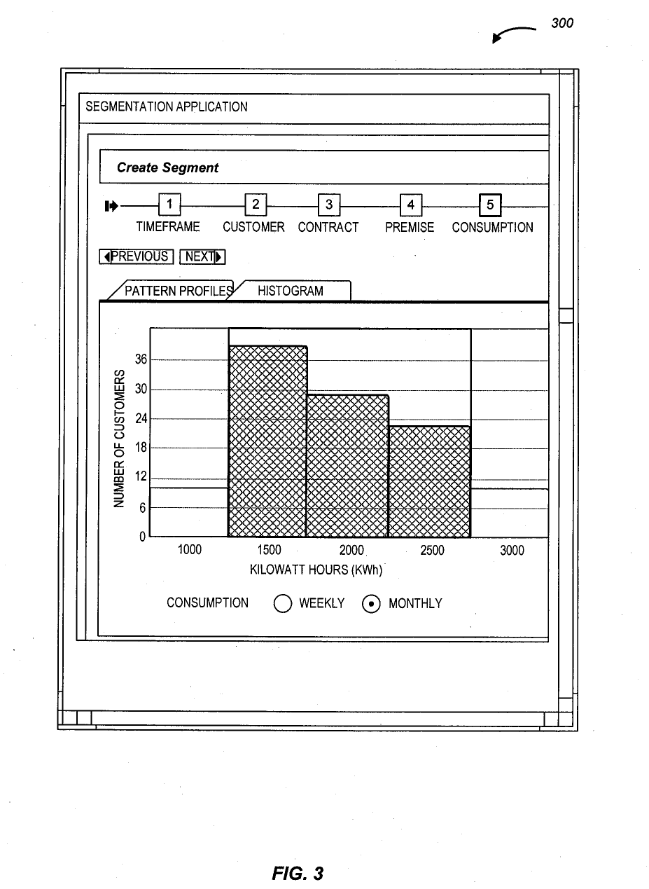

A histogram may thus be used to illustrate energy consumption ranges by customers during a selected period of time. An example user interface 300 comprising a histogram illustrating how many energy customers utilize respective amounts of energy during a particular month is shown in FIG. 3.

Smart meter data may also be used to identify customers responsible for the need to purchase energy on the spot market. These may be the customers that use energy in a manner that deviates from a predicted energy pattern. In one example embodiment, a segmentation application may be configured to access energy revenue data for a period of time and also access energy purchase cost information for the period of time. The revenue may be calculated by multiplying the amount of consumed energy by the rate charged per energy unit. The energy purchase cost information may include cost of energy purchased in advance and also the cost of energy purchased on the spot market. The smart meter data collected for a particular customer during a period of time, together with the revenue and cost data associated with that customer, may be used to determine relationship of the energy purchase cost for the period of time and the smart meter data for the customer. Thus, the segmentation application may be configured to identify particular customers that caused higher energy costs for the energy company (e.g., by consuming more than the predicted amounts of energy during the peak hours).

In one embodiment, a customer may be assigned a value score reflecting the relationship of the energy purchase cost for the period of time and the smart meter data for the customer. The assigned value score may be recorded in the customer's profile and may be calculated as a daily measure (i.e., each customer at any given day has a specific value score value). A value score may be calculated based on profitability, revenue, and cost-related customer scores. The types of scores that may be used in calculating a value score may be provided out-of-box and are shown in Table 2 below.

TABLE 2

| Category | Name | Formula for daily value |
|---|---|---|
| Consump- | Daily | sum(consumption) for 1 = 1 . . . 96 |
| tion | Consumption | |
| Revenue | Daily Revenue | sum(consumption*ratei) for 1 = 1 . . . 96 |
| | Daily Revenue v. | sum(consumption*ratei − energycost) for |
| | Energy Cost | 1 = 1 . . . 96 |
| | Daily Revenue v. | DailyRevenue − DailyCost2Serve |
| | Cost2Serve | |
| | Daily Revenue v. | sum(consumption*ratei − energycost) for |
| | Combined Cost | 1 = 1 . . . 96 − DailyCost2Serve |

In one embodiment, the rate values (ratei), the energy cost values (energycost), and the daily cost to serve values (DailyCost2Serve) are data imports. The value scores stored in respective customer profiles may be used to filter customer profiles for specific profitability score. An example user interface 400, provided by a segmentation application, the user interface 400 comprising a histogram illustrating how many energy customers have been assigned a particular value score is shown in FIG. 4.

As shown in FIG. 4, a segmentation application, permits a user to select a timeframe, for which the customer profiled are being segmented. The time frame filter may be designed to qualify all measure-based customer selection (e.g., value scores, consumption level, and profile) and certain specific attribute selections (e.g., location, tariff). The time frame may represent a static time period or a dynamic time period.

A static time period is characterized by a specific or fixed time selection. Regardless of when the segment is queried or exported, those customer profiles specifically meeting criteria during this specific time range are selected. For example, the time frame filter may be used to select all those customers who were on a certain tariff during the summer of 2010. The segmentation application may be configured to permit a user to choose a specific time range, to filter the selected time frame by specific day(s) of the week and/or by weekday and weekends, by specific dates in a calendar, etc. In some embodiments, the segmentation application may be configured to also permit a user to select those specific days that are higher/lower in terms of temperature, spot market prices, or overall consumption. The segmentation application may be configured to support the daily statistics such as daily temperature (min, max, average) for a specific region, spot market price, overall consumption (from all customers profiles accessible by the segmentation application).

A dynamic period is characterized by a rolling period that is ends on the most current date (e.g., the last data load) and starts a fixed number of days prior to the most current date. A user may be permitted to choose the most current date (e.g., the last data load), a preset period, year-to-date, quarter-to-date, month-to-date, rolling number of months or days (e.g., the last 12 months, the last 30 days, etc.), and a time period starting with any specific date and ending on the most current date. For example, if a date range of Jul. 1, 2010 and Jul. 31, 2010 is selected, this date range criterion is applied to any subsequent measure-based filter selections.

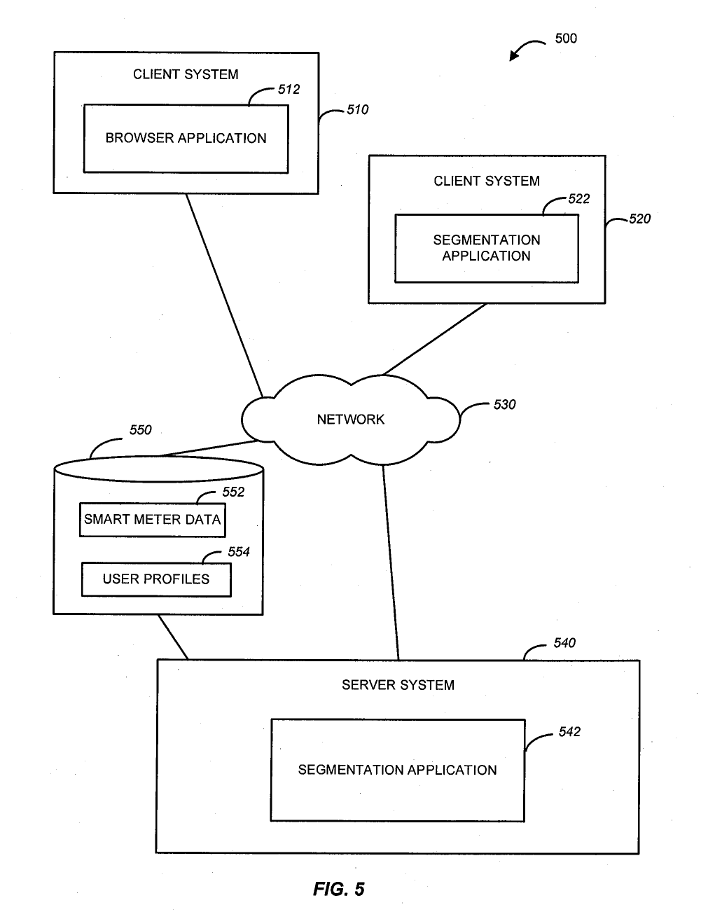

An example method and system to determine customer segmentation based on energy consumption patterns may be implemented in the context of a network environment 500 illustrated in FIG. 5. As shown in FIG. 5, the network environment 500 may include client systems 510 and 520 and a server system 540. The server system 540, in one example embodiment, may host a segmentation application 542. The segmentation application 542 may be configured to generate pattern profiles based on the smart meter data and to determine which customer profiles should be associated with a particular pattern profile. As shown in FIG. 5, the environment 500 may include a database 550 that may store smart meter data 552 and customer profiles 554.

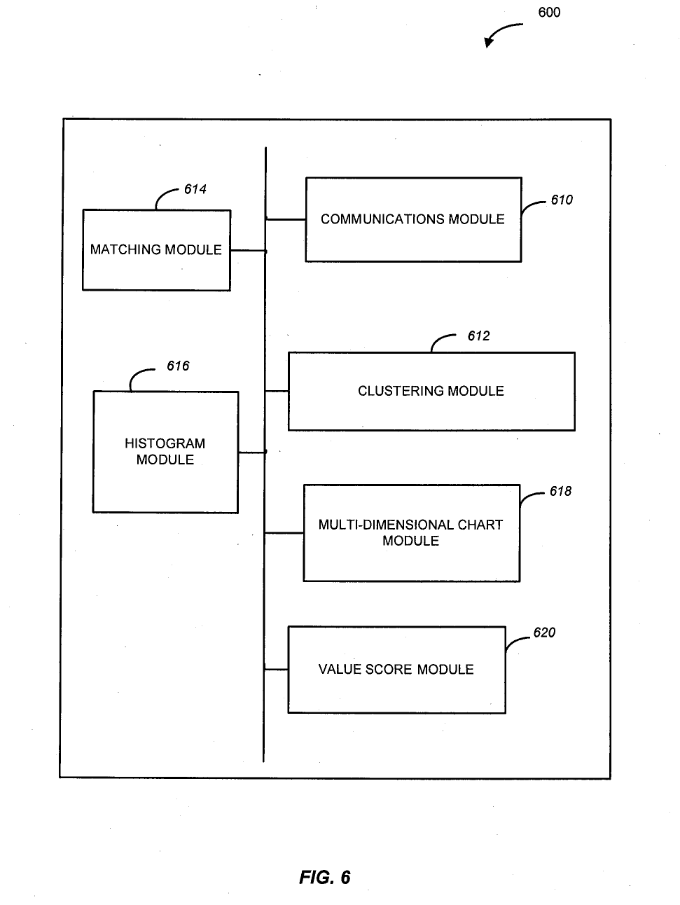

The client system 550 may utilize a browser application 512 to access the segmentation application 542 via a browser application 512 executing on the client system 510 via a communications network 530. The communications network 530 may be a public network (e.g., the Internet, a wireless network, etc.) or a private network (e.g., a local area network (LAN), a wide area network (WAN), Intranet, etc.). In some embodiments, a segmentation application may be executing locally with respect to a client system, such as, e.g., a segmentation application 522 executing on the client system 520. An example embodiment of a segmentation application is illustrated in FIG. 6.

FIG. 6 is a block diagram of a system 600 for segmenting customer profiles utilizing smart meter data, in accordance with one example embodiment. In some embodiments, the system 600 is a segmentation application that may be executing on a server computer system or on a client computer system. As shown in FIG. 6, the system 600 includes a communications module 610, a clustering module 612, and a matching module 614. The communications module 610 may be configured to obtain, e.g., from the client system 510 of FIG. 5, energy consumption data. The energy consumption data, in one embodiment, comprises a plurality of value days, where a value day comprises a plurality of energy consumption measurements at different times during a 24-hour period. Each value day contains measurements energy consumption measurements tae location of a particular energy customer and is thus associated with a customer profile. The communications module 610 is also configured to receive information defining the time frame for which the value days are accessed, e.g., via a graphical user interface.

The clustering module 612 may be configured to group the value days associated with a certain period of time into a set of clusters (also termed pattern profiles). A cluster thus comprises a subset of the value days associated with the certain period of time (e.g., the time frame selected via a graphical user interface). In one embodiment, the clustering module 612 is configured to perform grouping of the plurality of value days into a set of clusters periodically, e.g., on a weekly or monthly basis.

The matching module 614 may be configured to identify a customer profile as associated with a cluster from the set of clusters based on results of examining value days associated with the customer profile. In one embodiment, a customer profile is determined to be associated with a particular cluster if a predetermined portion or percentage of the value days associated with the customer profile are from the cluster. A user may be permitted to specify the threshold percentage for identifying a customer profile with a particular cluster, e.g., my means of the user interface 100 illustrated in FIG. 1. As explained above, the value days in a cluster from the set of clusters are characterized by similar respective energy consumption measurements. In one embodiment, the matching module 614 is to determine similarity between energy consumption measurements based on comparing absolute values of respective energy consumption measurements. In some other embodiments, the matching module 614 is to determine similarity between energy consumption measurements based on comparing normalized values of respective energy consumption measurements.

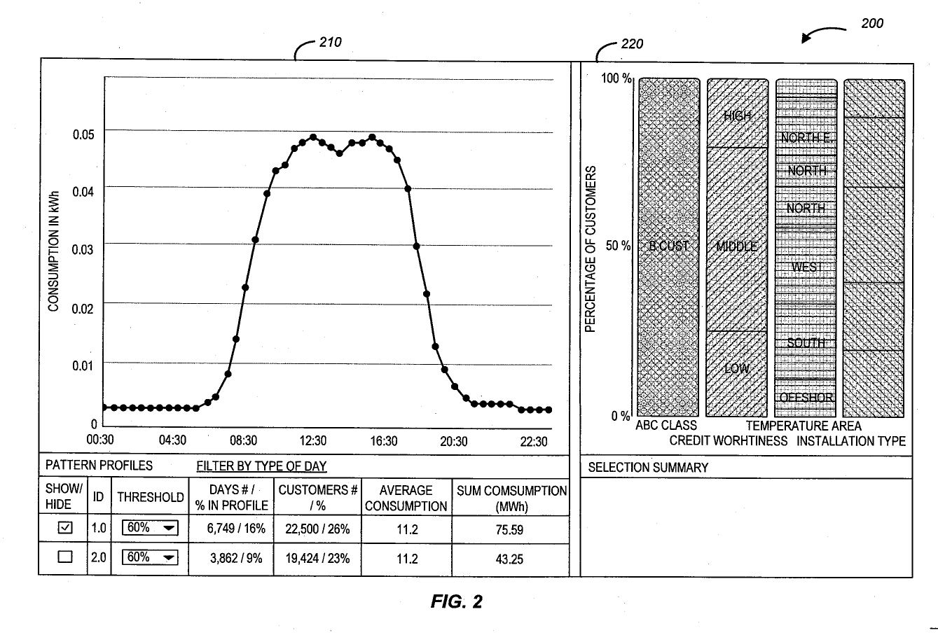

The system 600 may further include a histogram module 616 and a multi-dimensional chart module 618. The histogram module 616 may be configured to generate a histogram illustrating respective numbers of customers associated with ranges of energy consumption during a time period within a 24 hour period. As mentioned above, an example user interface showing such histogram is shown in FIG. 3. The multi-dimensional chart module 618 may be configured to access customer profiles identified as associated with the cluster from the set of clusters and generate a multi-dimensional chart illustrating statistics associated with the assessed customer profiles. An example user interface showing a multi-dimensional chart displayed simultaneously with a visual representation of energy consumption measurements associated with the cluster was described with reference to FIG. 2.

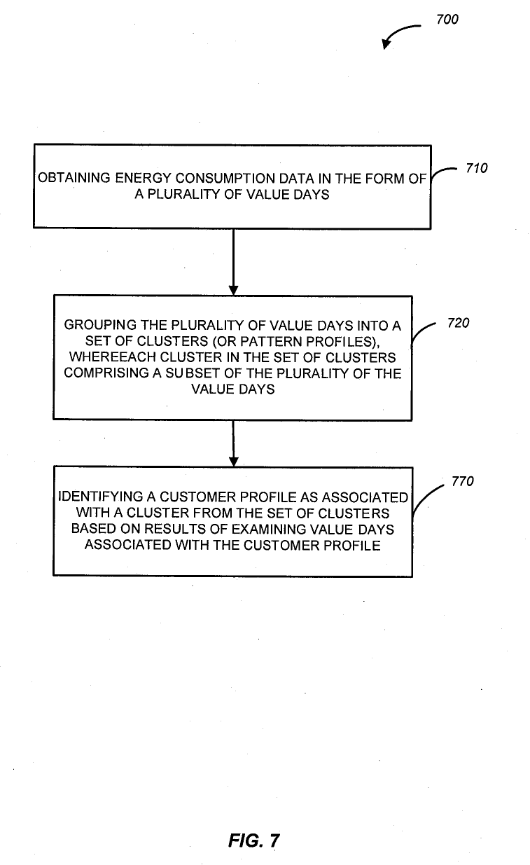

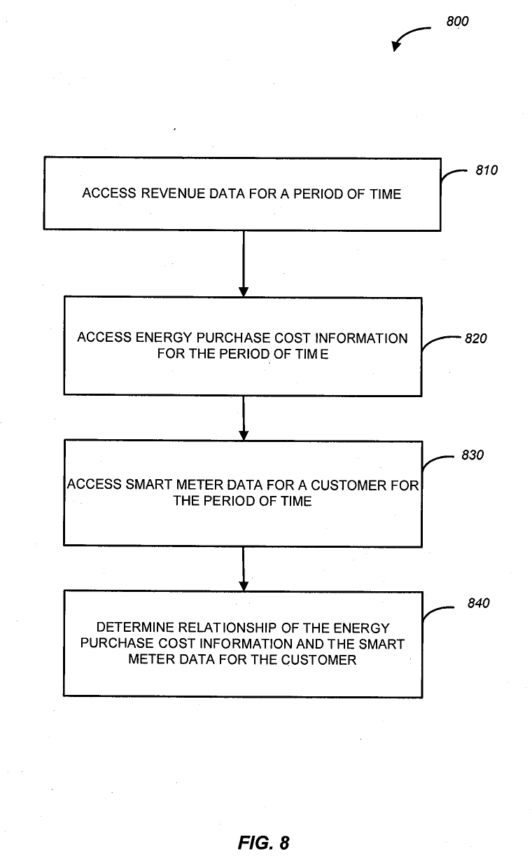

The system 600 may also include a value score module 620. The value score module 620 may be configured to determine, utilizing smart meter data, as well as energy cost and energy revenue data, a value score to be associated with a customer profile. Example methods performed by the system 600 can be described with reference to FIG. 7 and FIG. 8.

FIG. 7 is a flow chart of a method 700 for segmenting customer profiles utilizing smart meter data, according to one example embodiment. The method 700 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 540 of FIG. 5 and, specifically, at the system 600 shown in FIG. 6.

As shown in FIG. 7, the method 700 commences at operation 710, when the communications module 610 of FIG. 6 obtains energy consumption data comprising a plurality of value days, where each value day is associated with a customer profile from a plurality of customer profiles, each value day from the plurality of value days comprising a plurality of energy consumption measurements at different times during a 24-hour period. At operation 720, the clustering module 612 of FIG. 6 groups the plurality of value days into a set of clusters, where each cluster in the set of clusters comprises a subset of the plurality of the value days. The clustering module 612 may group the value days into clusters utilizing statistical approaches, such as, e.g., k-means algorithm. At operation 730, the matching module 614 of FIG. 6 identifies a customer profile as associated with a cluster from the set of clusters based on results of examining value days associated with the customer profile. For example, a user interface may be provided (such as, e.g., the user interface 100 shown in FIG. 1) that permits selecting a particular cluster and specifying the threshold percent of a customer's value days that would determine whether the customer's profile is to be associated with that cluster.

FIG. 8 is a flow chart of a method 800 for determining a value score for an energy customer utilizing smart meter data, according to one example embodiment. The method 800 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 540 of FIG. 5 and, specifically, at the system 600 shown in FIG. 6.

As shown in FIG. 8, the method 800 commences at operation 810, when the value score module 620 of FIG. 6 obtains revenue data for a period of time. At operation 820, the value score module 620 accesses energy purchase cost information for the period of time. At operation 830, the value score module 620 accesses smart meter data for a customer for the period of time. At operation 840, the value score module 620 determines relationship of the energy purchase cost information and the smart meter data for the customer.

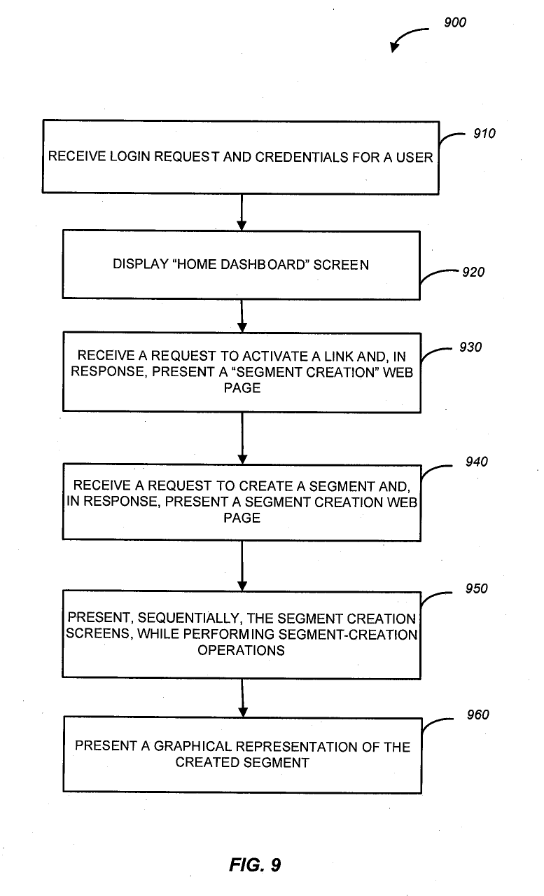

An example screen flow 900 that may be provided with a segmentation application is shown in FIG. 9. As shown in FIG. 9, as a user logs in (block 910), a “Home Dashboard” screen is displayed (block 920), where the user can activate various links, including a link to a segment creation web page (block 930). A segment creation web page is presented in response to a user's request (block 940). A user can step through segment-creation screens (block 950). A screen with a graphical representation of a newly-created segment can be viewed by the user (block 960).

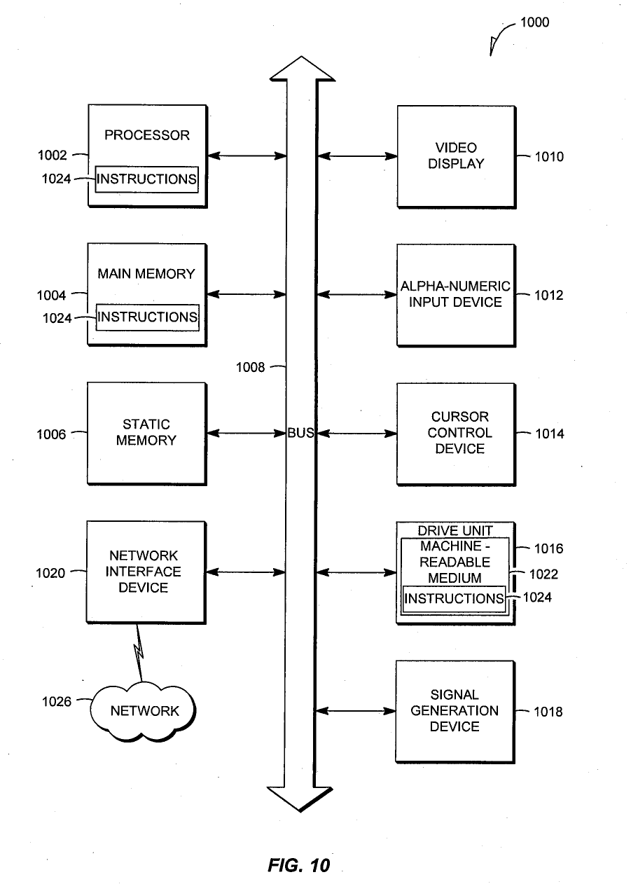

FIG. 10 shows a diagrammatic representation of a machine in the example form of a computer system 1000 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 10010. The computer system 1000 may further include a video display unit 1010 (e.g., a liquid crystal display (LCD) or a cathode ray tube (CRT)). The computer system 1000 also includes an alpha-numeric input device 1012 (e.g., a keyboard), a user interface (UI) navigation device 1014 (e.g., a cursor control device), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, with the main memory 1004 and the processor 1002 also constituting machine-readable media.

The software 1024 may further be transmitted or received over a network 1026 via the network interface device 1020 utilizing any one of a number of well-known transfer protocols (e.g., Hyper Text Transfer Protocol (HTTP)).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a method and system to determine customer segmentation based on smart meter data has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A method comprising:
obtaining energy consumption data, the energy consumption data comprising a plurality of value days, each value day from the plurality of value days being associated with a customer profile from a plurality of customer profiles, each value day from the plurality of value days comprising a plurality of energy consumption measurements at different times during a 24-hour period;
grouping the plurality of value days into a set of clusters, each cluster in the set of clusters comprising a subset of the plurality of the value days; and
identifying a customer profile as associated with a cluster from the set of clusters based on results of examining value days associated with the customer profile.

2. The method of claim 1, comprising receiving information defining a time frame, wherein the obtaining of energy consumption data comprises obtaining the energy consumption data for the time frame.

3. The method of claim 1, wherein the identifying of the customer profile as associated with the cluster comprises determining that a predetermined portion of the value days associated with the customer profile are from the cluster.

4. The method of claim 1, wherein value days in a cluster from the set of clusters are characterized by similar respective energy consumption measurements.

5. The method of claim 4, wherein similarity between energy consumption measurements is determined based on comparing absolute values of respective energy consumption measurements.

6. The method of claim 4, wherein similarity between energy consumption measurements is determined based on comparing normalized values of respective energy consumption measurements.

7. The method of claim 1, wherein the grouping of the plurality of value days into a set of clusters is performed periodically.

8. The method of claim 1 comprising generating a histogram illustrating respective numbers of customers associated with ranges of energy consumption during a time period within a 24 hour period.

9. The method of claim 1, comprising:
generating a visual representation of energy consumption measurements associated with a cluster from the set of clusters; and
accessing customer profiles identified as associated with the cluster;
generating a multi-dimensional chart illustrating statistics associated with the assessed customer profiles.

10. A method comprising:
accessing revenue data for a period of time;
accessing energy purchase cost information for the period of time;
accessing smart meter data for a customer for the period of time; and
determining relationship of the energy purchase cost information and the smart meter data for the customer.

11. A computer-implemented system comprising:
a communications module to obtain energy consumption data, the energy consumption data comprising a plurality of value days, each value day from the plurality of value days being associated with a customer profile from a plurality of customer profiles, each value day from the plurality of value days comprising a plurality of energy consumption measurements at different times during a 24-hour period;
a clustering module to group the plurality of value days into a set of clusters, each cluster in the set of clusters comprising a subset of the plurality of the value days; and
a matching module to identify a customer profile as associated with a cluster from the set of clusters based on results of examining value days associated with the customer profile.

12. The system of claim 11, wherein the communications module is to receive information defining a time frame, wherein the energy consumption data is the energy consumption data for the time frame.

13. The system of claim 11, wherein the matching module is to determine that a predetermined portion of the value days associated with the customer profile are from the cluster.

14. The system of claim 11, wherein value days in a cluster from the set of clusters are characterized by similar respective energy consumption measurements

15. The system of claim 14, wherein the matching module is to determine similarity between energy consumption measurements based on comparing absolute values of respective energy consumption measurements.

16. The system of claim 14, wherein the matching module is to determine similarity between energy consumption measurements based on comparing normalized values of respective energy consumption measurements.

17. The system of claim 11, wherein the clustering module is to perform grouping of the plurality of value days into a set of clusters periodically.

18. The system of claim 11, comprising a histogram module to generate a histogram illustrating respective numbers of customers associated with ranges of energy consumption during a time period within a 24 hour period.

19. The system of claim 11, comprising a multi-dimensional chart module to:
access customer profiles identified as associated with a cluster from the set of clusters; and
generate a multi-dimensional chart illustrating statistics associated with the assessed customer profiles.

20. A machine-readable non-transitory medium having instruction data to cause a machine to:
obtain energy consumption data, the energy consumption data comprising a plurality of value days, each value day from the plurality of value days being associated with a customer profile from a plurality of customer profiles, each value day from the plurality of value days comprising a plurality of energy consumption measurements at different times during a 24-hour period;
group the plurality of value days into a set of clusters, each cluster in the set of clusters comprising a subset of the plurality of the value days; and
identify a customer profile as associated with a cluster from the set of clusters based on results of examining value days associated with the customer profile.
